(19) United States
(12) Patent Application Publication
(10) Pub. No.: US 2012/0000256 A1
(43) Pub. Date: Jan. 5, 2012

(54) CLOSURE MEANS

(75) Inventor: David Martin Stuckey, Eltham (AU)

(73) Assignee: BURGUNDY TRIAL PTY LTD, Thomastown (AU)

(21) Appl. No.: 12/673,320

(22) PCT Filed: Aug. 13, 2008
(86) PCT No.: PCT/AU2008/001171

§ 371 Date: Feb. 19, 2010

(30) Foreign Application Priority Data
Aug. 14, 2007 (AU) 2007904347

(51) Int. Cl. E05B 65/00; B23P 17/04; E05C 19/00

(52) U.S. Cl. 70/91; 292/307 B; 29/428

(57) ABSTRACT

A closure means comprising a dish, having a perimeter flange, at least one side wall, a dish floor and a recessed area defined by the at least one side wall and the dish floor; and an opening formed in the dish floor of suitable size and shape to receive at least a part of a correspondingly shaped latching mechanism therethrough, wherein the latching mechanism comprises a non-rotatory outer housing and a rotatable inner actuator and wherein any gap existing between the opening and the latching mechanism is substantially reduced to minimise any fluid leakage therethrough.

### FIELD OF THE INVENTION

The present invention relates to a closure means comprising an improved sealing arrangement, preferably a closure means for use on an access point such as a door, a storage container, a compartment, a cover or hatch, and more particularly, in a situation where ingress of water has presented a problem. The closure means will most preferably be useful in vehicular applications.

### BACKGROUND OF THE INVENTION

There are many closure means presently in use on access points such as doors, covers and batches on sheet metal structures. The location of a handle within a door or hatch immediately comprises the integrity of that door or hatch by virtue of providing a passageway for fluid, such as water, air or gas to pass therethrough. A variety of sealing means such as rubber grommets, O-rings, seals and sealing compounds have been frequently used to limit leakage or passage of unwanted fluid from one side of the door or hatch to the other. In doors or cabinets behind which electrical componentry is stored, water leaking through any gap or passageway between the handle shaft and the door through which the shaft passes can have life-threatening consequences.

In train compartments, for example, air-conditioning units are located in the ceiling. In order to access these units, there is generally an opening or hatch located in the ceiling which provides access to such units. Air-conditioning units by the very nature of their operation generate water or condensation around them, which condensation might pool above an overhead hatch behind which the unit is located. If the overhead hatch has a handle shaft passing through it, any water that has accumulated behind it, can drip through the shaft passageway onto passengers travelling in the compartment.

The present invention seeks to provide a closure means which ameliorates and/or at least minimizes some of the disadvantages of the prior art. It is found that a closure means according to the present invention offers a number of possible advantages, such as a more readily accessible, less obtrusive and/or more secure closure means and more particularly, a closure means which has an improved capacity to protect against fluid, preferably water leakage through the opening through which the handle shaft is inserted.

### SUMMARY OF THE INVENTION

According to one aspect of the present invention, there is provided a closure means comprising:

a dish having a perimeter flange, at least one side wall, a dish floor and a recessed area defined by the at least one side wall and the dish floor, and
an opening formed in the dish floor of suitable size and shape to receive at least a part of a correspondingly shaped latching mechanism therethrough,
wherein the latching mechanism comprises a non-rotatory outer housing and a rotatable inner actuator and wherein any gap existing between the opening and the latching mechanism is substantially reduced to minimise any fluid leakage therethrough.

Preferably, the outer housing is fixable to, and is non-rotatory relative to, the dish floor. In order to minimise fluid leakage through the opening in the dish floor around the latching mechanism, the present invention preferably provides at least a first seal between the outer housing and the dish floor and at least a second seal between the inner actuator and the outer housing.

Preferably, the latching mechanism is externally actuatable. This can be achieved by way of a separate key means and/or handle means that can be, if desired, releasably affixed to the latching mechanism.

The dish, which provides the means for mounting the closure means into or onto the surface of a door, cover or hatch and/or the like, is preferably suitably shaped to at least partially accommodate the closure means therein. For this purpose, the dish preferably has a pair of opposing side walls. Preferably, each set of side walls extends from and diverges outwardly relative to the dish floor to end in the perimeter flange, which flange is substantially outwardly directed. The depth of the recessed area is selected such that the height that a latching mechanism might normally protrude above the mounting surface can be substantially reduced, thereby making it less prone to injuring passersby. In one form, the depth is such that it can receive that part of the latching mechanism in a substantially flush arrangement with the perimeter flange. In further forms, the depth is such that it can receive that part of the latching mechanism entirely within the recessed area. The dish is more preferably of a substantially rectangular configuration.

In certain embodiments of the present invention, the at least one side wall may be curved so as to define, for example, a partially or substantially rounded, ovoid or circular recessed area. Considerations of the depth of the recessed area are as described above.

In one preferred form, at least one side of the perimeter flange may extend outwardly to yield a substantially triangular apex region which can be used for the installation of a secondary locking means or fixing means to provide additional security and for fixing to the door, hatch and the like. Preferably, the flange is substantially parallel relative to the dish floor.

The latching mechanism comprises a non-rotatory outer housing preferably having a substantially open cylindrical body and a rotatable inner actuator. The outer housing preferably comprises a collar at its proximal end, a neck portion and a distal end. The distal end is preferably formed with a cut-out region, having at each end thereof an inner face portion. The outer housing preferably has a passageway therethrough. The neck portion is preferably threaded on its outer surface whereby the threads proceed circumferentially around the neck portion or alternatively, may be interspersed with flattened sections. Once the outer housing has been received into the dish, in order to render it non-rotatory relative to the dish floor, a fixing means is preferably applied to substantially fix the outer housing to the dish. The fixing means is preferably a threaded nut which thread is complementary to the threads on the neck portion. In an alternative embodiment, the fixing means is preferably a clip or clamp means.

A rotatable inner actuator, which is preferably substantially circular in cross-section or having at least one portion thereof which is circular, is provided with a suitably shaped key-receiving end supported on a lip portion and at least one stepped portion/s, decreasing in diameter towards a working end. The working end preferably comprises a substantially open receiving means for cooperating with a cam or tongue means, being releasably attachable thereto. The working end is preferably formed with an inner threaded portion for receiving a fastening means to secure the cam or tongue means to the working end of the inner actuator. In an alternative form, the inner actuator is preferably provided with an external threaded portion to which the cam or tongue means is releasably attachable.

The inner actuator is preferably operable by an external actuating means, for example, a key means and/or handle means cooperating with the key receiving end thereof. When actuated by the actuating means, the cam or tongue means attached to the working end of the inner actuator is preferably caused to work in unison with the inner actuator, such that when the inner actuator is placed in a locked condition, the cam or tongue is also placed in a locked condition.

The inner actuator is rotatable relative to the outer housing. The inner actuator is preferably receivable and substantially retained within the open cylindrical passageway of the outer housing and is preferably capable of axial and/or slidable displacement and rotation therewithin. The angle of rotation of the inner actuator within the outer housing is preferably limited by the size of the cut-out region on the distal end of the outer housing. The cut-out region is preferably adapted to cooperate with a protrusion located on the cam or tongue means. The protrusion is preferably formed with at least one external face/s, which is/are adapted to engage the at least one inner face/s of the cut-out region of the distal end of the outer housing. In one form, the latching mechanism is in its locked condition, i.e. when the at least one external face of the protrusion is/arc in contact with at least one inner face of the cut-out region. Rotation of the inner actuator through a pre-determined angle of rotation preferably causes the at least one external face of the protrusion to move out of contact with its corresponding inner face of the cut-out region and simultaneously thereby preferably causes the attached cam or tongue means to rotate in unison with the inner actuator, whereupon the latching mechanism is placed in an unlocked condition. The angle of rotation can be determined by the respective size of the cut-out region of the distal end of the housing and/or the size and configuration of the protrusion.

In a preferred form, that part of the latching mechanism that lies within the recessed area of the dish does not at least substantially protrude out thereof. This has the advantage of protecting passersby from being injured by handles protruding from a ceiling or the like. Alternatively, in a different application, the latching mechanism can be fitted with a handle member attached to the inner actuator. In this form, the external actuating means is not required as the handle member itself can be rotated to permit opening of the access point. In a preferred form, the handle is more preferably a T-bar or D-shaped handle. More preferably, the handle is foldable such that it is accommodated within the recessed area of the dish.

To install the closure means of the present invention on a door or hatch or the like, prior to the latching mechanism being inserted through the opening in the dish floor, a first seal is preferably fed over the body of the outer housing and is located underneath the collar. The latching mechanism is then inserted into the opening so that the first seal becomes positioned between the collar and the upper inner surface of the dish floor. The seal is preferably constructed so that the shape of the internal opening thereof corresponds with the shape of the opening in the dish floor. Further, since the outer housing of the present invention is non-rotatory, the life of this first seal can be substantially prolonged.

The latching mechanism of the present invention further preferably comprises at least one second seal, which is located separately from the first seal, the second seal being preferably located on the body of the inner actuator and internally of the passageway of the outer housing. The at least one second seal is/are preferably retained in position beneath the lip portion of the inner actuator. In this way, the inner actuator is also sealed against the ingress of fluid. By incorporating the at least one second seal, the latching mechanism is sealed both externally of the outer housing as well as internally thereof thereby improving the fluid-sealing, preferably water-sealing, capability of the latching mechanism.

The opening formed in the dish floor, which preferably corresponds to the outer shape and dimensions of the outer housing, can be selected from the universal cut-out or from the “DD” shaped cut-out and the like. The universal cut-out is preferably of a substantially square-shaped configuration having a side dimension of 20.1±0.5 millimetres and a diagonal length of 22.5±0.5 millimetres. Alternatively, the DD cut-out is of a substantially obloid configuration having one length of 14.6±0.1 millimetres and the other length of 17.8±0.2 millimetres.

The cam or tongue means of the present closure means is preferably provided with an opening for engagement with the working end of the actuator and also for receiving the fastening means for securing the cam or tongue means thereto. The cam is provided with a substantially V-shaped end, which is adapted to engage with or be receivable within and pass through and/or move along a recess or slot provided in or on the sheet metal structure to which the closure means is attached. The cam is preferably designed so that the leading edge of the end thereof engages with the inner surface of the sheet metal structure and is urged thereagainst to prevent the cam from rattling against the sheet metal structure.

The closure means of the present invention can be secured to the sheet metal structure to which it is to be attached, by one or more fastening means. In one form, the fastening means comprises studs and corresponding nuts, wherein the studs are attached, preferably by welding, to the underside of the perimeter flange of the dish, which studs protrude through openings in the sheet metal structure and, are secured in position on the unexposed side of the sheet metal structure. In this way, additional security may be provided to the access point since the closure means cannot be readily removed from the exposed side of the sheet metal structure. In an alternative form, the perimeter flange of the dish may be fitted with additional opening/s, whereby the closure means can be secured to the sheet metal structure to which it is attached, preferably by screw/s or the like.

The latching mechanism used in the present invention may also preferably be used in conjunction with a secondary locking mechanism, which may be fitted to the opening provided in the perimeter flange of the dish. The secondary locking mechanism can be of any typical type as known and used in the art. In a preferred aspect, the locking mechanism can include a lock cylinder or a barrel and key arrangement. In another preferred form, the locking mechanism is of the push-button type comprising a lock cylinder or barrel with an outwardly urged button connected to a lock means, such as a lock pawl, which is substantially retracted into the lock cylinder upon application of pressure upon the biased button. Preferably, the locking mechanism is of the high security barrel type, which is operable via a separate key. In this way, two people are required to open the access point, which would be suitable for high security applications.

In a further preferred embodiment, the inner actuator may be spring loaded. The advantage of using such an inner actuator is that any sudden vibration or bump to which the vehicle or train is subjected, will not cause the closure means to be accidentally dislodged.

The inner actuator used in the present invention is preferably constructed of stainless steel which assists in prolonging the life of the latching mechanism in environments where water may be present.

In specific embodiments, the present invention provides a dish-mounted latching mechanism which includes any or all of the above-described features relating to the closure means. Specifically, the dish-mounted latching mechanism comprises a dish together with a latching mechanism mounted therein, substantially as hereinbefore described.

### DESCRIPTION OF THE DRAWINGS

Other features and advantages of one or more preferred embodiments of the present invention will be readily apparent to one of ordinary skill in the art from the following written description with reference to and used in conjunction with the accompanying drawings in which:

FIG. 1 is a perspective view of one preferred form of the closure means of the present invention;

FIG. 2 is an exploded view of the closure means of FIG. 1, without the optional secondary locking mechanism in position;

FIG. 3 is an exploded side view of a preferred form of the latching mechanism of the present invention;

FIG. 4 is an exploded end-on view of the latching mechanism of FIG. 3;

FIG. 5 is a perspective view of the distal end of the outer housing;

FIG. 6 is a perspective view of the cam or tongue means; and

FIG. 7 is a side on cross-sectional view of the closure means of FIG. 1 installed on a door or hatch.

### DETAILED DESCRIPTION OF THE PREFERRED EMBODIMENT

The following describes a preferred embodiment of the present invention. The present invention is not to be limited in scope by the specific embodiments described herein, which are intended as single illustrations of individual aspects of the invention, and functionally equivalent methods and components are included within the scope of the invention. Indeed, various modifications of the invention, in addition to those shown and described herein will become apparent to those skilled in the art from the foregoing description and accompanying drawings. Such modifications are intended to fall within the scope of the appended claims.

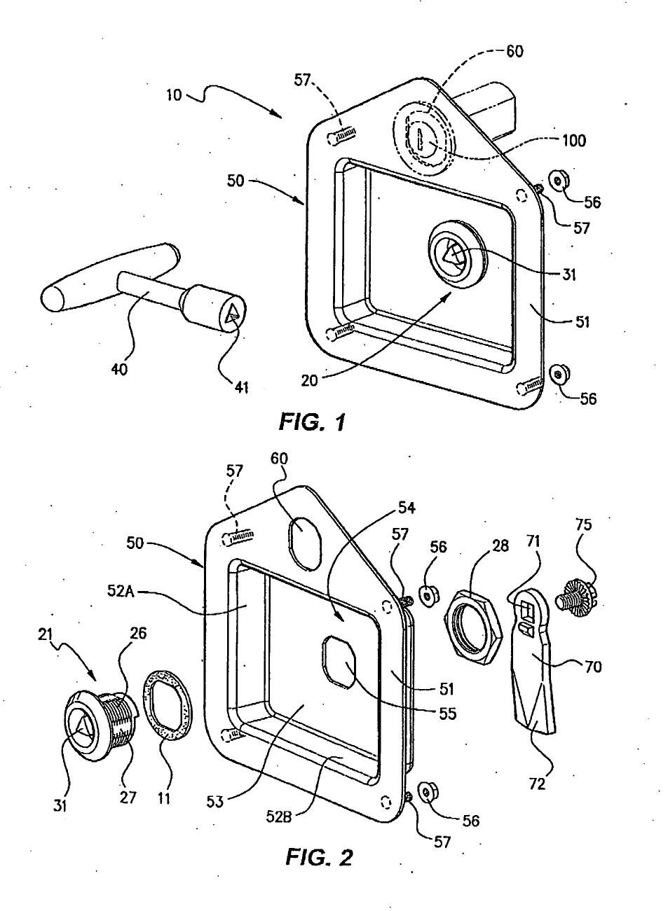

Referring to all the drawings, like reference numerals designate like or corresponding parts throughout the several views. Referring initially to FIG. 1, the closure means 10 includes a latching mechanism 20 which mechanism is receivable within a dish 50 wherein the latching mechanism 20 in an in-use situation is preferably the means by which a door, cover or hatch 90 which is to be placed in a locked condition is accessed.

Referring to FIGS. 1 and 2, the dish 50 comprises a perimeter flange 51, at least one pair of opposing side walls 52A and 52B, a floor 53 and a recessed area 54 formed by the dish floor 53 and the at least one pair of side walls 52A for receiving a latching mechanism 20.

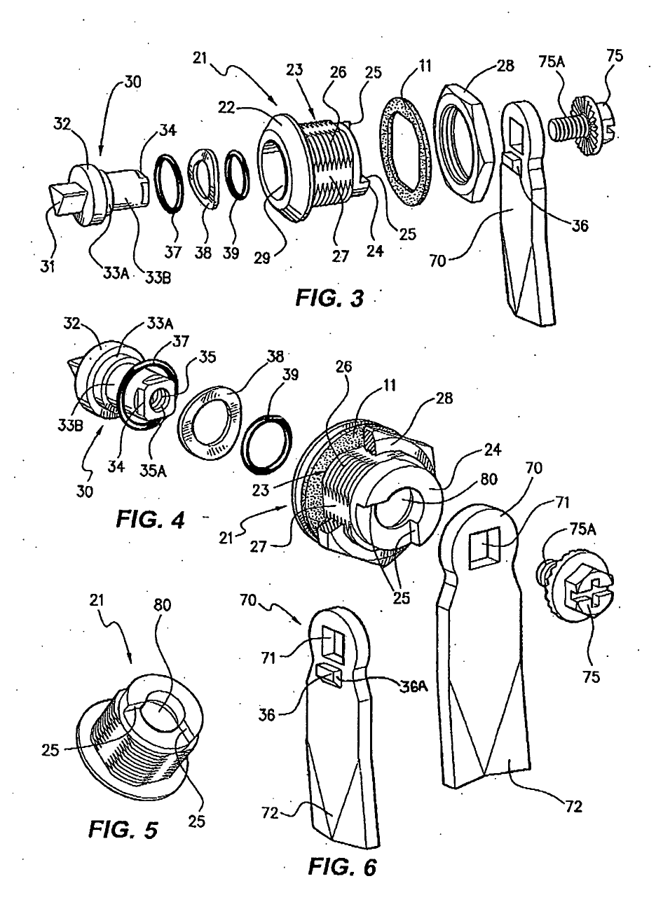

With reference to FIGS. 3, 4 and 5, the latching mechanism 20 comprises a non-rotatory outer housing 21 and an inner rotatable actuator 30. The outer housing 21 comprises a collar 22, a threaded neck portion 23 and a distal end 24, where the distal end 24 is formed with a cut-out region 24A, having at each end thereof inner face portions 25. The housing 21 has a passageway 80 passing therethrough. The threaded neck portion 23 comprises threads 26 proceeding circumferentially around the neck portion 23 interspersed with flattened sections 27.

The inner actuator 30 comprises at least one second seal 37 and at least one retaining ring/s 38 and 39 which is/are fed over the working end 34 and located beneath the lip portion 32. The inner acutator is then placed internally of the passageway 80 of the outer housing 21. The at least one second seal 37, together with retaining ring/s 38 and 39 preferably seal the passageway 80 of the housing 21 against the ingress of fluid. Therefore, by incorporating this second seal, the latching mechanism 20 is sealed both externally of the outer housing 21 as well as internally thereof thereby improving the fluid-sealing, preferably water-sealing, capability of the latching mechanism 20.

The inner actuator 30 is rotatable relative to the outer housing 21. The actuator 30 is receivable and substantially retained within the open cylindrical passageway 80 of the outer housing 21 and is capable of axial and/or slidable displacement and rotation therewithin. The degree of rotation within the outer housing 21 can be determined by the size of the cut-out region 24A on the distal end 24 of the outer housing 21. The cut-out region 24A is adapted to cooperate with a protrusion 36 located on the cam or tongue means 70. The protrusion 36 is preferably substantially rectangular in configuration being formed with at least one external face/s 36A which is/are adapted to engage the at least one inner face/s 25 of the cut-out region 24A of the distal end 24 of the outer housing 21. In one form, the latching mechanism 20 is in its locked condition, i.e. when the at least one external face 36A of the protrusion is/are in contact with at least one inner face 25 of the cut-out region 24A. Rotation of the inner actuator 30 through a pre-determined angle of rotation causes the at least one external face 36A of the protrusion 36 to move out of contact with its corresponding inner face 25 of the cut-out region 24A and simultaneously thereby causes the attached cam or tongue means 70 to rotate in unison therewith whereupon the latching mechanism 20 is placed in an unlocked condition. The angle of rotation can be determined by the respective size of the cut-out region 24A of the distal cad 24 of the outer housing 21 and/or the size and configuration of the protrusion 36.

The inner actuator 30 is provided with a suitably shaped key-receiving end 31 supported by a lip portion 32 and a series of stepped portions 33A and 33B, each decreasing in diameter towards a working end 34. The working end 34 is adapted to cooperate with a cam or tongue means 70 and also comprises a substantially open receiving means 35 for reversible attachment to a cam or tongue means 70. The open receiving means 35 is preferably formed with an inner threaded portion 35A for receiving a fastening means 75 having a thread 75A corresponding to the inner threaded portion 35A to secure the cam or tongue means 70 to the working end 34 of the actuator.

The cam or tongue means 70 is provided with an opening 71 for receiving the fastening means 75 for securing the cam or tongue 70 to the working end 34 of the actuator 30. The cam is provided with a substantially V-shaped end 72 which is adapted to engage with or be receivable within and pass through and/or move along a recess or slot (not shown) provided in or on the sheet metal structure 90 to which the closure means 10 is attached. The cam 70 is designed so that the leading edge of the end 72 engages with the inner surface (not shown) of the sheet metal structure 90 and is urged thereagainst to prevent the cam 70 from rattling against the sheet metal structure 90.

The inner actuator 30 is operable by an external actuating means 40, having a suitably shaped end 41, which shape corresponds to the key-receiving end 31 of the inner actuator 30. When actuated by the actuating means 40, the cam or tongue means 70 attached to the working end 34 of the inner actuator 30 is caused to work in unison with the inner actuator 30, such that when the inner actuator 30 is placed in a locked condition, the cam or tongue means 70 is also placed in a locked condition.

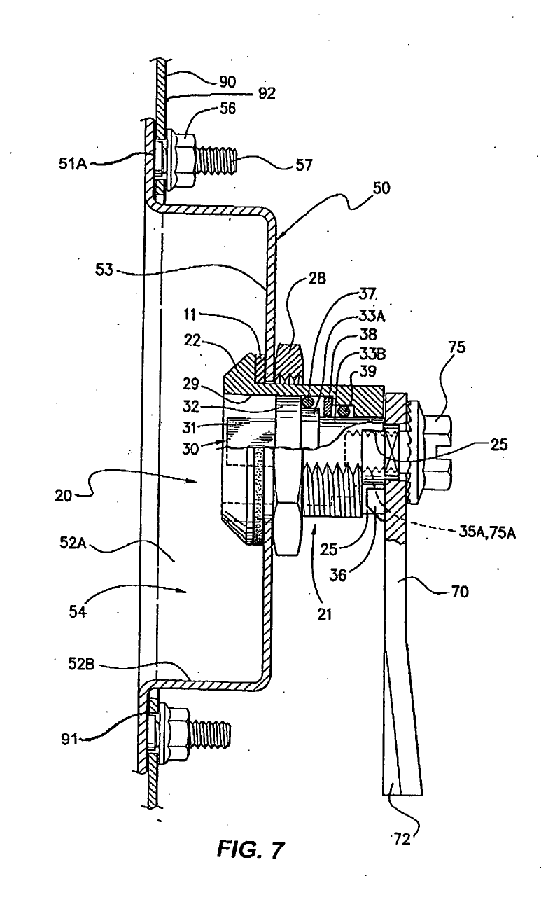

To install the closure means 10 of the present invention onto a door or hatch 90 and referring to FIG. 7, a suitably shaped opening is cut out of the door or hatch 90 for receiving the dish 50 therein. Additional openings 91 are then cut out of the door or hatch 90 for receiving the threaded studs 57 located, preferably by welding, to the underside 51A of the perimeter flange 51 of the dish 50. Nuts 56 are then complementarily threaded onto studs 57 for securing the dish 50 to the unexposed side 92 of door or hatch 90.

Before the latching mechanism 20 is located in opening 55 of dish 50, a first seal 11 is fed over the outer housing 21 and is located underneath the collar 22. The latching mechanism 20 is then inserted into the opening 55 in the dish floor 53 with the first seal 11 being located between the collar 22 and the upper surface of the dish floor 53. Once the outer housing 21 has been received into the dish 50, in order to render it non-rotatory relative to the dish, a fixing means 28 is preferably applied to substantially fix the housing 21 to the underside of the dish floor 53 of dish 50.

Referring to FIG. 2, the opening 55 formed in the dish floor 53 conforms to the shape of the universal cut-out. In one form, the closure means is secured to the door or hatch 90 to which it is attached, by way of fastening means.

By using the actuating means 40, the latching mechanism 20 is able to be placed into an unlocked condition thereby providing access to the door, cover/hatch or compartment (not shown), by rotating the cam or tongue means such that it is out of contact with the inner surface of the sheet metal structure 90 to which the closure means 10 is attached.

The latching mechanism 20 used in the present invention may also be used in conjunction with a secondary locking mechanism 100 which may be fitted to the opening 60 provided in the perimeter flange 51 of the dish 50.

An example of a latching mechanism suitable for use in the present invention is one manufactured and produced by DIRAK®, which is the registered trade mark of Ramsauer Konstruktionselementc GmbH and Co. KG; however the invention is not limited to mechanisms made by this manufacturer. The present invention provides users with an opportunity to select and purchase a variety of inner rotating actuators, which may be suitable for their particular application, each of which would preferably be compatible with the dish of the closure means of the present invention. In one preferred embodiment of the present invention, the actuator may be of the push-button code type arrangement, which may be preferable in some situations to having an external key means.

The advantage provided in one form of the invention when required for certain applications of having the actuating means or key means being detachable from the closure means is that the closure means can only be accessed by an authorized person or persons and once activated, the actuating or key means may be disengaged and stored separately from the actuator for security purposes. In this way, additional security can be provided against the access point being opened inadvertently or by other unauthorised means. Furthermore, since in this form, a handle means is not permanently attached to the inner actuator, there is no danger of it being left in an open and protruded state, which may endanger passersby. The advantage provided by having the shape of the dish as hereindescribed being compatible with existing handles of this type, is that if retrofitting is required, the old handle may be simply removed, and the new closure means with its improved latching mechanism contained therein can be readily retrofitted.

The present invention is also suitable for use on compartments on the sides of fire engines and trucks, where access to hoses and the like contained within such compartments is required very quickly. In the past, difficulty has been experienced in manipulating recessed handles, particularly where firemen have had bulky fireproof gloves on their hands. The advantage provided by the present invention is that simply by using an external activating lever or key, access to the inside of the compartment can be much more readily obtained.

Therefore the earlier disadvantages detailed in relation to previous handle arrangements can be overcome or at least substantially ameliorated by the present invention.

Where the terms “comprise”, “comprises”, “comprised” or “comprising” are used in the specification, they are to be interpreted as specifying the presence of the stated features, integers, steps or components referred to, but not to preclude the presence of one or more feature, integer, step, component or group thereof.

Further, any prior art reference or statement provided in the specification is not to be taken as an admission that such art constitutes, or is to be understood as constituting, part of the common general knowledge in Australia.

Those skilled in the art will appreciate that although the invention described herein for simplicity sake has referred in particular to vehicular applications it has general applicability to other compartments, doors, lids, toolboxes etc. It is to be understood that the invention includes all variations and modifications of the feature identified including all types of closure means and locks referred to or indicated in the specification individually or collectively and any and all combinations of any two or more of said features.

1-21. (canceled)

22. A closure including:
a dish having a dish floor, a side wall, a perimeter flange, and a recessed area defined by the side wall and the dish floor;
a latching mechanism including a non-rotatory outer housing and a rotatable inner actuator;
the latching mechanism being received within an opening formed in the dish floor, wherein any gap between the opening and the latching mechanism is at least substantially fluid-tight.

23. The closure of claim 22 wherein the outer housing includes a cylindrical body having an inner passageway housing the inner actuator therewithin.

24. The closure of claim 22 wherein the depth of the recessed area is such that the latching mechanism does not protrude above the perimeter flange.

25. The closure of claim 22 further including a secondary lock provided on the dish, the secondary lock being separate and spaced from the latching mechanism.

26. The closure of claim 22 wherein a handle member is attached to the inner actuator, wherein the handle member is rotatable to move the closure between a locked condition and an unlocked condition.

27. The closure of claim 26 wherein the handle is selected from a T-bar or D-shaped handle, and wherein the handle is foldable to enable its accommodation within the recessed area of the dish.

28. The closure of claim 22 further including a first seal between the outer housing and the dish floor and a second seal between the inner actuator and the outer housing.

29. The closure of claim 28 wherein the outer housing is fixable to and is non-rotatory relative to the dish floor.

30. The closure of claim 28 wherein the outer housing includes a proximal end bearing a collar, a distal end, and a neck portion therebetween, wherein the distal end is formed with a cut-out region having at each end thereof an inner face portion, and
wherein an outer surface of the neck portion bears threads, the threads being interspersed with flattened sections spaced circumferentially about the outer surface.

31. The closure of claim 30 wherein the inner actuator has an at least substantially circular cross-section, and includes a key-receiving end supported on a lip portion, a stepped portion, and decreases in diameter towards a working end, wherein the working end includes an aperture therein.

32. The closure of claim 31 wherein the aperture is formed with an inner threaded portion receiving a fastener, the fastener releasably securing a tongue to the inner actuator.

33. The closure of claim 31 wherein the first seal is located substantially under the collar of the outer housing and the second seal is located substantially separately from the first seal, the second seal being substantially located on the inner actuator and substantially internally of the outer housing.

34. The closure of claim 33 wherein the second seal is substantially retained in position beneath the lip portion of the inner actuator.

35. The closure of claim 31 wherein the inner actuator is rotatable relative to the outer housing, and wherein the inner actuator is receivable and substantially retained within a cylindrical passageway defined in the outer housing and is capable of axial and/or slidable displacement and rotation therewithin, the angle of rotation of the inner actuator within the outer housing being limited by the size of the cut-out region on the distal end of the outer housing.

36. The closure of claim 35 wherein the inner actuator is operable by an external actuator cooperating with the key receiving end thereof, and includes a tongue on the working end, wherein when actuated by the external actuator, the tongue moves in unison with the inner actuator, whereby when the inner actuator is placed in a locked condition, the tongue is simultaneously placed in a locked condition.

37. The closure of claim 36 wherein the cut-out region is configured to cooperate with a protrusion located on the tongue, wherein the protrusion is formed with an external face oriented at least substantially perpendicular to the tongue, and adapted to engage the inner face of the cut-out region of the distal end of the outer housing.

38. The closure of claim 37 wherein the latching mechanism is in a locked condition when the external face of the protrusion is in contact with the inner face of the cut-out region and wherein rotation of the inner actuator through a pre-determined angle of rotation causes the external face of the protrusion to move out of contact with its corresponding inner face of the cut-out region simultaneously thereby causing the attached tongue to rotate in unison therewith, whereupon the latching mechanism is placed in an unlocked condition.

39. The closure of claim 38 wherein the angle of rotation is determined by the size of the cut-out region of the distal end of the outer housing and/or the size and configuration of the protrusion.

40. A method of assembling the closure of claim 31 including:
locating a first seal over the body of the outer housing and locating it under the collar thereof;
locating the second seal on the body of the inner actuator and internally of a passageway within the outer housing, and employing the lip portion of the inner actuator to retain the second seal in position; and
inserting the latching mechanism into the opening in the dish floor,
wherein the first seal is positioned between the collar and the inner surface of the dish floor.

41. The assembly method of claim 40 wherein the shape of the internal opening of the first seal corresponds with the shape of the opening in the dish floor.
